(19) United States
(12) Patent Application Publication
(10) Pub. No.: US 2002/0050698 A1
(43) Pub. Date: May 2, 2002

(54) Connection of conductors conducting support services in draft-drawn vehicles

(75) Inventor: Andries S. F. Dippenaar, Pretoria (ZA)

Correspondence Address: SENNIGER POWERS LEAVITT AND ROEDEL, ONE METROPOLITAN SQUARE, 16TH FLOOR, ST LOUIS, MO, 63102, US

(73) Assignee: Pasangran Corporation N.V.

(21) Appl. No.: 10/003,867

(22) Filed: Oct. 31, 2001

(30) Foreign Application Priority Data
Oct. 31, 2000 (ZA) 2000/6176
Apr. 26, 2001 (ZA) 2001/3435

(51) Int. Cl. B60R 16/00

(52) U.S. Cl. 280/422

(57) ABSTRACT

An articulated vehicle 210 comprises a truck tractor 212 and a trailer 214, shown pivoted relative to the truck tractor. Services, especially electrical and hydraulic services used for lighting and control, are conducted from the truck tractor 212 to the trailer 214 by means of conductors 226 (only one conductor is shown connected to the trailer). A connecting device 220 includes a hollow arm 222 pivoted at one end via a pivotal joint 234 and a bracket 236 to the truck tractor. Service conductors 226 anchored on the truck tractor are carried via the joint 234, which is hollow for this purposes to be connected with little lost motion to the trailer. The arm 222 pivots with the trailer and protectingly carries the conductors 226.

THIS INVENTION relates to connection of conductors conducting support services between vehicles coupled in draft-drawn configuration. It relates more specifically to a method of connecting service conductors between a fore vehicle and a rear vehicle, to a connecting device for connecting service conductors, and to an articulated vehicle.

Typically, the invention finds application in an articulated vehicle in which the fore vehicle is in the form of a truck tractor as it is colloquially known. In this specification, the term “horse” may be used, and should then be interpreted as a synonym for “truck tractor”. The rear vehicle is in the form of a trailer.

The Applicant expects the invention to find particularly advantageous application in heavy articulated vehicles and that application will predominantly be borne in mind for purposes of this specification. In a heavy articulated vehicle, for example a vehicle including a truck tractor or horse and a trailer, the truck tractor or horse (i.e. the fore or draft vehicle) and the trailer (i.e. the rear or drawn vehicle) are coupled by means of a “fifth wheel” or turntable arrangement via which pulling effort is transmitted from the fore vehicle to the rear vehicle while pivoting is permitted. The invention is likewise applicable to composite articulated vehicles where more than one pivoted coupling are provided, e.g. from a truck tractor or horse to a first trailer, and from the first trailer to a rear trailer. The principle and even the detail application are the same for both or all couplings and only one coupling, typically between a truck tractor or horse and a trailer, is described for purposes of this specification.

The services transmitted from a fore vehicle (e.g. the truck tractor) to the rear vehicle (e.g. the trailer) include typically electrical power via electrical cables having a number of conductors, e.g. for indicator lights, stop lights, rear lights, and the like; and fluid under pressure via one or more fluid conductors respectively for unlocking normally activated brakes of the trailer to render the trailer in the running condition, and for controlling braking of the brakes of the trailer, or for other functional purposes.

In accordance with a first aspect of this invention, there is provided a method of connecting service conductors between a fore vehicle and a rear vehicle coupled in draft-drawn configuration about a pivot axis allowing relative pivoting between the fore and rear vehicles to negotiate bends during steering, the method including supporting the service conductors on and guiding the service conductors by means of a self-supporting arm pivotally anchored at a pivoted end about an upright pivot axis on a first of the fore and rear vehicles and connecting a free end of the self-supporting arm remote from the pivoted end to the second of the fore and rear vehicles to cause the free end to follow the second vehicle during relative pivoting between the fore and rear vehicles.

Conveniently, connecting said free end of the self-supporting arm to the second vehicle may be by having the service conductors extending between the free end of the self-supporting arm and the second vehicle with limited lost motion, the service conductors then being connected to the second vehicle. The connecting device may include lengths of the conductors. At an end of that arm which is not anchored, the conductors may extend with excess length and may have connecting members for readily connecting the conductors in their service lines. The connecting members may have valves which open when the connections are made and which close when the connections are broken.

The method may include permanently or semi-permanently supporting or anchoring the arm on the first vehicle and likewise permanently or semi-permanently connecting the service conductors to the first vehicle. The method may then include rendering the service conductors readily connectible and disconnectable by means of complemental pairs of connecting members respectively at ends of the service conductors and the second vehicle. For service conductors conducting fluid, e.g. pneumatic conductors, the connecting members may include valves which close automatically upon disconnection and open automatically upon connection.

When the fore and rear vehicles are coupled by means of a fifth wheel arrangement, the method may advantageously include positioning the self-supporting arm at a position longitudinally spaced from a king pin or pivot axis of the fifth wheel arrangement, for example to the rear of the king pin or pivot axis. Thus, pivotal anchoring of the self-supporting arm may preferably be to a chassis of the fore vehicle proximate the fifth wheel arrangement, such that the arms extend generally rearwardly from the pivotal anchor point underneath a platform or floor of the rear vehicle. The Applicant has found that, generally, in the zone behind the fifth wheel arrangement, below the floor of the rear vehicle, i.e. generally between longitudinal chassis beams of the rear vehicle, much space is available with no components penetrating that space. A connecting device in accordance with the invention can thus operate unimpeded in such zone.

In a variation of the method, the self-supporting arm may be provided as a composite arm comprising two sections which are pivoted to each other. When the fore and rear vehicles are then coupled by means of a fifth wheel arrangement, the method may include positioning said self-supporting composite arm to a side of the fifth wheel, generally laterally spaced from a king pin or pivot axis of the fifth wheel arrangement. Pivotal anchoring of the self-supporting arm may preferably be to a chassis of the fore vehicle proximate the fifth wheel arrangement, such that the self-supporting arm extends generally laterally. The Applicant is of the opinion that this variation can successfully be used when the zone behind the fifth wheel arrangement may not be vacant, for example in some tipper trucks. Generally, more freedom of play in the conductors may be required, thus the two-sectioned, inter-pivoted arm may be provided.

Generally, supporting the service conductors on the self-supporting arm may be by having the arm longitudinally hollow and securing the service conductors to extend internally along the arm. The arm or arm sections may be tubular, however, they are advantageously provided as channels (preferably partially closed channels) having inwardly turned lips narrowing the channel opening.

In accordance with a second aspect of this invention, there is provided a connecting device for connecting service conductors conducting services from a fore vehicle to a rear vehicle which are coupled in draft-drawn configuration to allow pivoting about a pivot axis allowing relative pivoting between the fore and rear vehicles to negotiate bends during steering, the connecting device including

a self-supporting arm adapted to carry the service conductors;

a pivotal anchoring formation at one end of the self-supporting arm for pivotally anchoring the arm on a substrate.

The arm may advantageously be hollow to carry the service conductors internally. Likewise, advantageously, the pivotal anchoring formation may be hollow to pass the service conductors internally. However, instead, the service conductors may be coiled around the pivotal anchoring formation. The latter has the advantage of merely linking the conductors over a long length during pivoting rather than twisting them over a short length.

In another embodiment the arm may be a composite arm comprising two sections which are pivoted to each other about an intermediate pivot joint. The sections may respectively be rigid. The intermediate pivot joint may be hollow to pass the service conductors internally, if desired. Then the or each pivot joint may have bushes or grommets of a non-abrasive material to protect the conductors against abrasion and cutting. Pivot axes of the pivotal anchoring formation and the intermediate pivot joint may be parallel.

In accordance with a third aspect, the invention extends to an articulated vehicle comprising a fore vehicle and a rear vehicle which are pivotally coupled about an upright pivot axis and in which service conductors conducting services from the fore vehicle to the rear vehicle are supported on and guided by means of a connecting device in accordance with the second aspect of this invention.

When the fore and rear vehicles are coupled by means of a fifth wheel arrangement, the connecting device may be anchored on one of the fore and rear vehicles spaced from a king pin of the fifth wheel arrangement proximate a periphery of the fifth wheel arrangement.

When the arm is a simple arm formed by a single rigid section, its pivotal anchoring formation may be mounted on a chassis of the fore vehicle rearwardly of a king pin of the fifth wheel arrangement.

Instead, when the arm is a composite arm formed by two, inter-pivoted sections which may respectively be rigid, the pivotal anchoring formation may be mounted on a chassis of the fore vehicle laterally of a king pin of the fifth wheel arrangement, i.e. to have the arm extending generally laterally.

The invention is now described by way of examples with reference to the accompanying diagrammatic drawings. In the drawings

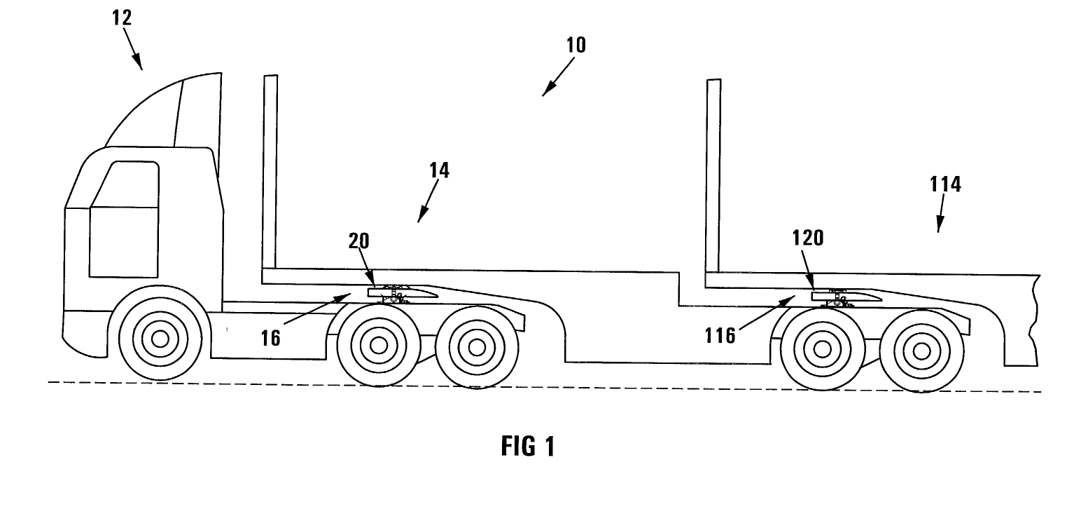

FIG. 1 shows in side view, a composite articulated vehicle including a truck tractor, a first trailer, and a rear trailer coupled in accordance with this invention;

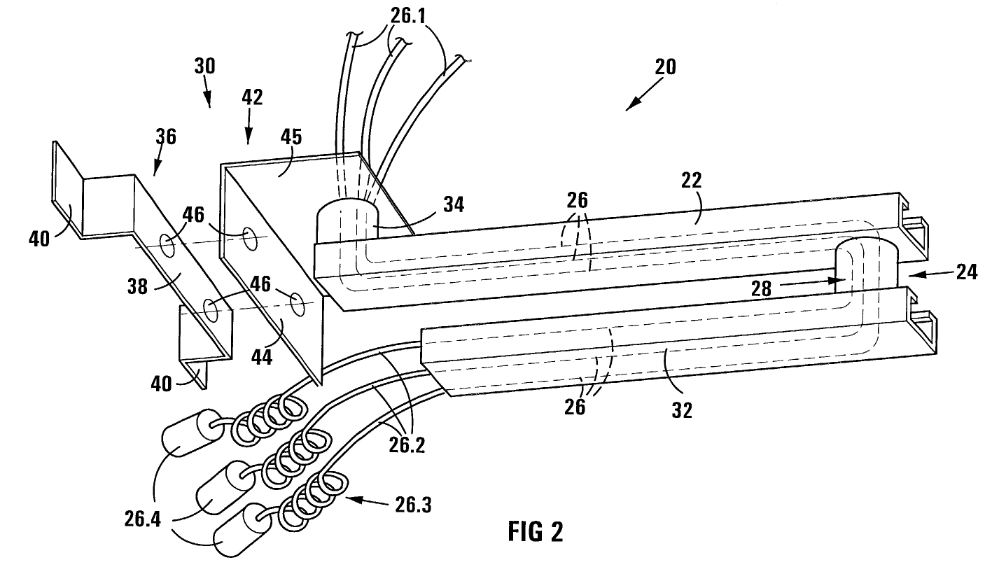

FIG. 2 shows, in three dimensional side view, a first embodiment of a connecting device in accordance with the invention;

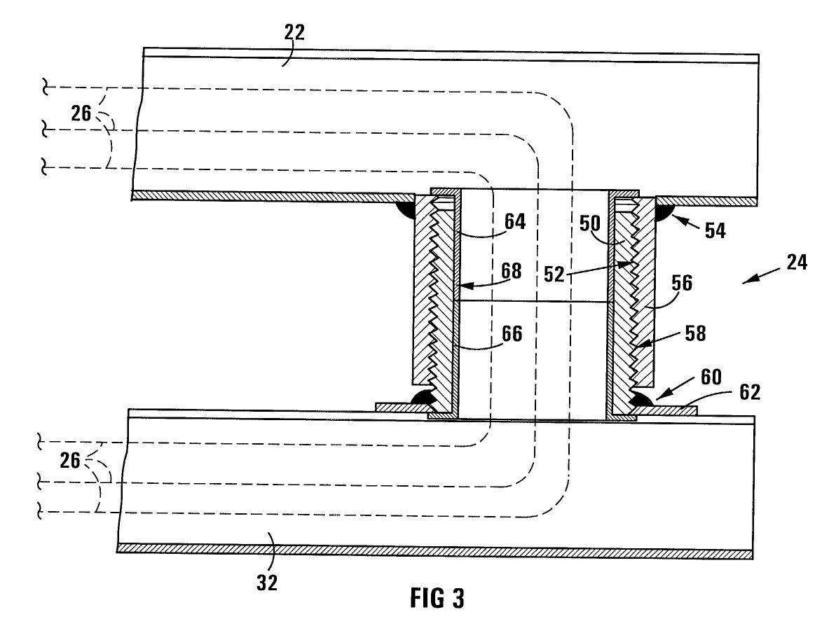

FIG. 3 shows, in longitudinal section, a pivoted joint of the device of FIG. 2;

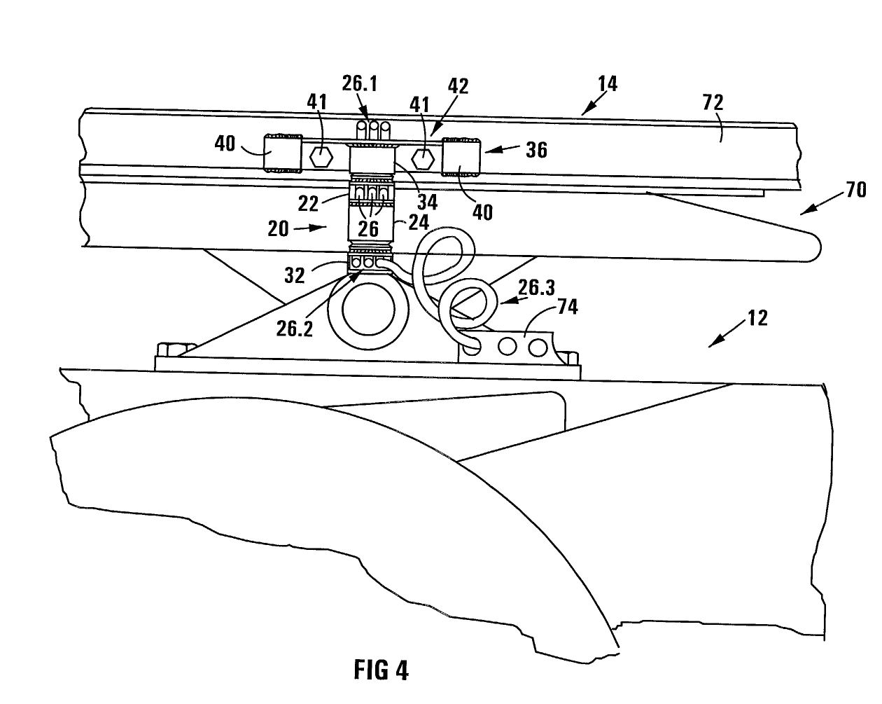

FIG. 4 shows the device of FIG. 2 mounted on the articulated vehicle of FIG. 1 in a view which is lateral in relation to the articulated vehicle and which is end on in relation to the device of FIG. 2; and

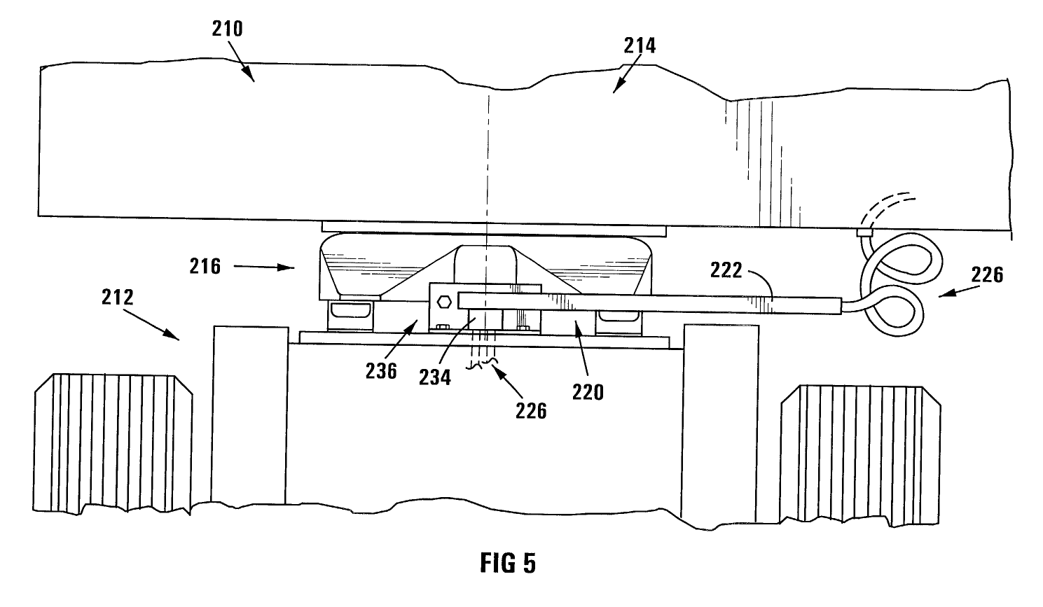

FIG. 5 shows a preferred variation of the device of FIG. 2, the preferred device being shown mounted on the vehicle of FIG. 1, in a view showing the articulated vehicle in pivoted condition.

With reference to FIGS. 1 to 4 of the drawings, and more specifically FIG. 1, a composite articulated vehicle of the kind to which this invention is typically and advantageously applied, is indicated by reference numeral 10. The articulated vehicle 10 includes a truck tractor 12, a front trailer 14 coupled to the truck tractor 12 via a fifth wheel arrangement 16, and a rear trailer 114 coupled to the front trailer 14 by means of a fifth wheel arrangement 116. A coupling 20 in accordance with this invention, and as will be described in more detail hereinafter, is used to connect service conductors leading from the truck tractor 12 to the front trailer 14. The device 20 is advantageously mounted on the front trailer 14 and the truck tractor 12 proximate the fifth wheel arrangement 16, but it can also be mounted at other positions. However, advantageously, it is mounted proximate a pivot point between the front trailer 14 and the truck tractor 12. A second device 120 connects the service conductors leading from the front trailer 14 to the rear trailer 114, in similar fashion. For purposes of this specification, and with reference to FIGS. 2 to 4, the device 20 will hereinafter be described as a person of reasonable skill in the art will easily understand that the connection between the front trailer 14 and the rear trailer 114 can be effected in virtually identical fashion to the connection between the truck tractor 12 and the front trailer 14. A variation, which is preferred, is described with reference to FIG. 5.

With reference more specifically to FIG. 2, the device 20 comprises a first elongate arm 22 which, in this embodiment, is in the form of a rigid, angled section of steel. The device 20 further includes a second arm 32, also in the form of a rigid, angled section of steel. The first arm 22 and the second arm 32 are pivotally connected at one ends thereof by means of an arm pivot joint 24, which is an intermediate pivot joint in accordance with the invention.

An opposed end of the first arm 22 is mounted on mounting means 30 by means of a mounting pivot joint 34 similar to, practical identical to, the pivot joint 24, and which is a pivotal anchoring formation in accordance with the invention.

Service conductors generally indicated by reference numeral 26 and which typically include an electrical cable comprising a plurality of electrical conductors, and two pneumatic pipes extend from a position where they are connected to the front trailer 14 as indicated by reference 26.1, via the pivot joint 34, the first arm 22, the pivot joint 24 and the second arm 32 to project as indicated by reference numerals 26.2 from the device 20. Beyond the position 26.2, the service conductors are typically coiled to take up excess length as indicated by reference numeral 26.3 and they terminate in connector members 26.4 for ready connection to complemental connecting members of the truck tractor 12.

It is to be appreciated that, in other embodiments, the device 20 can be anchored on the truck tractor, the conductors can be permanently or semi-permanently connected to the truck tractor and free ends thereof can readily be connectable to the trailer.

The mounting means 30 comprises a fixed bracket 36 having a centre section 38 and a pair of cranked lugs 40 at either end of the centre section 38. The cranked lugs 40 are typically welded to the trailer 14, more specifically to a longitudinal beam of the trailer as will be described with reference to FIG. 4.

The mounting means 30 further comprises an angled bracket 42 having a fixing limb 44 which is mounted to the centre section 38 of the fixed bracket 36 by means of bolts 41 (FIG. 4) via registered holes 46 in respectively the fixing limb 44 and the centre section 38. The angled bracket 42 further comprises a decumbent limb 45 from which the pivot joint 34 depends.

The pivot joint 24 is now described in more detail with reference to FIG. 3. It is to be understood that the pivot joint 34 is identical or virtually identical to the pivot joint 24 and is not separately described.

The pivot joint 24 includes a male sleeve 50 having an external screw thread 52 and which is fixed to said one end of the second arm 32 via a transverse strap 62 by means of welding as shown at 60. The pivot joint 24 further includes a complemental female sleeve 56 having internal screw thread 58 and which is welded as indicated by reference numeral 54 to the first arm 22. It is to be appreciated that the joint 24 can be dismantled and can be reassembled if required. In use, it will be threaded such that it has lost motion of at least one revolution in the tightening direction.

The pivot joint 24 further includes a pair of complemental grommets 64, 66 in the form of bushes, of a non-abrasive material, such as nylon, teflon, or the like. The grommets 64, 66 line an internal passage 68 through the joint 24.

In this embodiment, the conductors 26 are conveniently threaded through the passage 68 to extend from the first arm 22 to the second arm 32. In other embodiments, if desired, the conductors 26 can exit the first arm 22 via its end, can be looped around the female sleeve 56 and can re-enter the second arm 32 via its open end. The advantage of the embodiment illustrated is that the conductors 26 are continuously protected and guided. The advantage of the alternative embodiment, which is not illustrated, is that coiling the conductors ameliorates twisting of the conductors during pivoting of the pivot joint 24.

With reference to FIG. 4, as alluded to above, the fixed bracket 36 is fixed to the longitudinal beam indicated at 72 of the front trailer 14 such that the device 20 is anchored on said longitudinal beam 72. The ends 26.1 of the conductors 26 are permanently or semi-permanently connected in line to extensions of the conductors 26.

The coiled portions 26.3, of which one only is shown in FIG. 4, extend from the free end of the second arm 32 and the connecting members 26.4 are anchored to a support plate 74 mounted on the truck tractor 12. Thus, the free end of the second arm 32 is indirectly held proximate the support plate 74 and is thus connected in that position on the truck tractor 12 during use, i.e. merely by tension in the conductors 26.

When the composite articulated vehicle 10 turns, the first arm 22 pivots about the pivot joint 34 to take up partially relative motion between the front trailer 14 and the truck tractor 12 on account of turning. The first arm 22 thus acts as a swing arm swinging from the mounting means 30. The second arm 32 further swings via the pivot joint 24 relative to the free end of the first arm 22 further to take up relative motion between the truck tractor 12 and the front trailer 14 on account of turning.

It is very important to appreciate that the service conductors 26 are fully guided and protected from the position at 26.1 where they enter the pivot joint 34, to the position 26.2 where they exit the free end of the second arm 32. The ends 26.1 are permanently or semi-permanently connected such that there is no or virtually no free movement of the conductors in that area. Similarly, the ends 26.2 and the relatively short excess lengths in the coils 26.3 are temporarily connected to corresponding connecting members of the truck tractor 12 in such a way that the conductors, in that area, are guided with only little freedom of motion such that they cannot interfere or be interfered with and are thus practically immune from damage. It is just as important to appreciate that the lengths of the first and second arms 22, 32 and the absolute freedom by means of which they can swing allow a very large arc through which the articulate vehicle can turn without any stress or strain on the device 20. In fact, the lengths of the arms are selected that they can accommodate at least the full arc, in both directions, through which the truck tractor and trailer can turn relative to each other.

Advantageously, strips may be slid along the arms 22, 32 below the lips at the tops of the channel sections to close the channels and to enclose the conductors.

There is a very large number of important advantages afforded by the invention. Some of these are mentioned below and they will readily be understood by a person skilled in the art.

The main advantage is that the invention ensures to a much better degree than previously that the service conductors are protected from damage and breakdown and thus greatly enhances the integrity of the system. Because the conductors are properly guided and because sufficient freedom of movement is allowed, the invention practically totally prevents interference by structure on the vehicle with the conductors, chafing of the conductors against each other and against structure of the vehicle, cutting of the conductors against sharp edges or structure of the vehicle, over-stretching of the conductors due to interference, fouling and the like. This advantage leads to a number of subsidiary advantages, for example reduction in down-time on trucks, savings due to fewer breakdowns, for example saving on maintenance costs, cost of the vehicle personnel in respect of overtime pay, time and costs of mechanics and support systems for mechanics, especially bearing in mind that breakdowns frequently occur at inopportune times in remote locations. The invention to a large extent prevents consequential damage due to breakdowns, for example spoiling of the cargo, damage to the vehicle and theft of the cargo because of the vehicle's being in a broken down state at the side of the road. Thus, the reliability and integrity of the system are greatly enhanced.

Another very important general advantage is in respect of road safety, in that the chances of a breakdown, affecting brakes, lighting, and the like are greatly reduced. It is well known that many accidents are caused by trailers without appropriate rear lights, stop lights, indicators, and the like.

A subsidiary advantage which the Applicants believe is important is that, where substantial free space between a front of the trailer and the rear of a cab or cab structure (for example long distance fuel tanks behind the cab) had to be provided previously, virtually no extra free space needs to be provided in a vehicle in accordance with this invention. As vehicles are limited to a specific overall maximum length, it is an advantage that the usable cargo length can be increased because, first, less space is required with a connecting device in accordance with this invention, and, secondly, the amount of space required is certain and specified and not a matter of estimation requiring a safety factor. Thus, the capacity of vehicles can be increased enhancing the usage efficiency of vehicles.

With reference to FIG. 5, a further embodiment, which is a preferred embodiment, of a connecting device in accordance with the invention is generally indicated by reference numeral 220. The connecting device 220 is similar in many respects and operates on the same principle as the device 22 described with reference to FIGS. 1 to 4. Thus, emphasis will be placed on differences and the device 220 will not again be described in detail.

The main difference between the device 220 and the device 22, and which is also the advantage which the device 220 has over the device 22, is that the device 220 has only one arm 222 which is pivotally mounted by means of a pivot joint 234 and a bracket 236 on a fore vehicle 212 of an articulated vehicle 210 comprising also a trailer or rear vehicle 214. Having only one arm simplifies manufacture, installation and working of the device 220 compared to the device 22. It also renders the device more compact.

The bracket 236 may be a composite bracket comprising a first bracket portion in the form of a length of angled section arranged transversely. A first limb is conveniently secured on a decumbent substrate of the truck tractor by means of existing bolts. A second bracket portion, also in the form of a length of angled section, is secured to the second limb of the first bracket portion in back-to-back relationship to form the composite bracket. The pivot joint 234 is secured to project from the free or second limb of the second bracket portion.

In FIG. 5, the view is taken from the rear onto the fore vehicle or truck tractor 212 whereas the rear vehicle or trailer 214 is shown to have been pivoted substantially, for example through about 90°, relative to the truck tractor 212. The trailer 214 is coupled to the truck tractor 212 via a fifth wheel arrangement generally indicated by reference numeral 216.

In accordance with this aspect, the device 220 is mounted on the truck tractor 212 immediately to the rear of the fifth wheel arrangement 216 and underneath a floor of the trailer 214. The Applicant has found that, in a large proportion of articulated vehicles, in that area, there is ample space to provide a connecting device in accordance with the invention. It furthermore has the advantage that the device 220 is out of harm's way.

The arm 222 pivots by means of the pivotal joint 234 via the mounting bracket 236 which is fixed to the truck tractor 212. The arm 222 pivots generally in accordance with pivoting of the trailer 214 and carries the service conductors 226 (only one service conductor being shown connected to the trailer 214) as shown in the drawing.

A person of ordinary skill in the art will easily be able to apply features described with reference to the embodiment of FIGS. 1 to 4, also to the embodiment of FIG. 5 and those features are thus not again described.

1. A method of connecting service conductors between a fore vehicle and a rear vehicle coupled in draft-drawn configuration about a pivot axis allowing relative pivoting between the fore and rear vehicles to negotiate bends during steering, the method including supporting the service conductors on and guiding the service conductors by means of a self-supporting arm pivotally anchored at a pivoted end about an upright pivot axis on a first of the fore and rear vehicles and connecting a free end of the self-supporting arm remote from the pivoted end to the second of the fore and rear vehicles to cause the free end to follow the second vehicle during relative pivoting between the fore and rear vehicles.

2. A method as claimed in claim 1 in which connecting said free end of the self-supporting arm to the second vehicle is by having the service conductors extending between the free end of the self-supporting arm and the second vehicle with limited lost motion.

3. A method as claimed in claim 1, when coupling the fore and rear vehicles by means of a fifth wheel arrangement, positioning the self-supporting arm at a position longitudinally spaced from a king pin or pivot axis of the fifth wheel arrangement.

4. A method as claimed in claim 3 in which pivotal anchoring of the self-supporting arm is to a chassis of the fore vehicle proximate the fifth wheel arrangement, such that the arms extend generally rearwardly from the pivotal anchor point underneath a platform or floor of the rear vehicle.

5. A method as claimed in claim 1 in which the self-supporting arm is a composite arm comprising two sections which are pivoted to each other.

6. A method as claimed in claim 5, when coupling the fore and rear vehicles by means of a fifth wheel arrangement, positioning said self-supporting composite arm to a side of the fifth wheel arrangement, generally laterally spaced from a king pin or pivot axis of the fifth wheel arrangement.

7. A method as claimed in claim 6 in which pivotal anchoring of the self-supporting arm is to a chassis of the fore vehicle proximate the fifth wheel arrangement, such that the self-supporting arm extends generally laterally.

8. A method as claimed in claim 1 in which supporting the service conductors on the self-supporting arm is by having the arm longitudinally hollow and securing the service conductors to extend internally along the arm.

9. A connecting device for connecting service conductors conducting services from a fore vehicle to a rear vehicle which are coupled in draft-drawn configuration to allow pivoting about a pivot axis allowing relative pivoting between the fore and rear vehicles to negotiate bends during steering, the connecting device including
a self-supporting arm adapted to carry the service conductors;
a pivotal anchoring formation at one end of the self-supporting arm for pivotally anchoring the arm on a substrate.

10. A connecting device as claimed in claim 9 in which the arm is hollow to carry the service conductors internally.

11. A connecting device as claimed in claim 9 in which the pivotal anchoring formation is hollow to pass the service conductors internally.

12. A connecting device as claimed in claim 9 in which the arm is a composite arm comprising two sections which are pivoted to each other about an intermediate pivot joint.

13. A connecting device as claimed in claim 12 in which the intermediate pivot joint is hollow to pass the service conductors internally.

14. A connecting device as claimed in claim 12 in which pivot axes of the pivotal anchoring formation and the intermediate pivot joint are parallel.

15. An articulated vehicle comprising a fore vehicle and a rear vehicle which are pivotally coupled about an upright pivot axis and in which service conductors conducting services from the fore vehicle to the rear vehicle are supported on and guided by means of a connecting device as claimed in claim 9.

16. An articulated vehicle as claimed in claim 15 in which pivotal coupling of the fore and rear vehicles is by means of a fifth wheel arrangement, the connecting device being anchored on one of the fore and rear vehicles spaced from a king pin of the fifth wheel arrangement proximate a periphery of the fifth wheel arrangement.

17. An articulated vehicle as claimed in claim 15, in which the self-supporting arm is in the form of a rigid arm whose pivotal anchoring formation is mounted on a chassis of the fore vehicle rearwardly of a king pin of the fifth wheel arrangement.

18. An articulated vehicle comprising a fore vehicle and a rear vehicle which are pivotally coupled about an upright axis and in which service conductors conducting services from the fore vehicle to the rear vehicle are supported on and guided by means of a connecting device as claimed in claim 12, in which the two sections of the self-supporting arm are respectively rigid and in which the pivotal anchoring formation is mounted on a chassis of the fore vehicle laterally of a king pin of the fifth wheel arrangement.
